(19) United States
(12) Patent Application Publication
(10) Pub. No.: US 2017/0182951 A1
(43) Pub. Date: Jun. 29, 2017

(54) Magnetic Attachment Panel

(71) Applicant: Denise Shepherd, Bakersfield, CA (US)

(72) Inventor: Denise Shepherd, Bakersfield, CA (US)

(21) Appl. No.: 14/980,694

(22) Filed: Dec. 28, 2015

(51) Int. Cl. B60R 11/02

(52) U.S. Cl. CPC B60R 11/0252; B60R 2011/0012

(57) ABSTRACT

The magnetic attachment panel is used to display a computer tablet, toys, and other useful objects for entertainment of persons and in particular children. The magnetic attachment panel has a flexible base panel and a plurality of magnets either attached to the surface of the flexible base panel or integrated into the flexible base panel at magnetic sections. The magnets create magnetic fields at the magnetic sections sufficient to magnetically attach a computer tablet housed within a computer tablet retainer. Similarly, toys or other objects may be removably attached to the flexible base panel if that have a metallic composition, or metallic accessory tabs or harness attached to them. After use, the magnetic attachment panel can be easily rolled into a closed position for transportation and/or storage. The magnets ensure that the magnetic attachment panel remain in the closed position when not in use.

### FIELD OF THE INVENTION

The present invention pertains generally to a panel for use in the area of displaying and storing utilitarian objects. More specifically, the present invention pertains to a flexible base panel with integrated magnets used to attach objects for display or storage. The present invention is particularly, but not exclusively, useful for converting ordinary objects such as automobile seats into entertainment centers for automobile passengers.

### BACKGROUND

Entertaining children can be a difficult task for parents who have multiple demands on their time. In cars, children often become uncomfortable and bored, causing them to act out. There is little parents can do to entertain their children when they are focused on driving.

In a recent study, pediatric researchers have indicated that small children under the age of two years old can, and should interact with touch screen devices like tablet computers. In fact, interacting with a tablet computer for at least one hour a day can teach a young infant “cause and effect” by providing a reward when they press a button on the screen or interact with the device.

Unfortunately, giving young children a touch-screen device in a car or other places can be problematic without strict adult supervision. First, infant and younger children have issues with holding the device, which may cause the device to fall and get damaged. Second, children tend to enjoy putting objects that are in their hands into their mouths, which can also damage the device. Third, the child may decide to act out and throw the device that is in their hands. Therefore, the parent has to monitor the child constantly while they are using the device.

Moreover, video monitors fully integrated into the vehicle are expensive and typically do not possess the wide array of movies, games, and other applications designed for entertaining and/or educating children. Thus, there is a need for convenient storage and display of a tablet that can be out of reach of young children, but still as prominent and visible as conventional fully integrated automobile monitors.

In addition to the car, there are other locations where the parent may wish to give their child a device without a constant need for direct monitoring when the child is using the device. For example, a crib or carrier where the child is playing or sitting.

Therefore, there is a need for a device capable of removable attachment to a vehicle and capable of holding a computer tablet in place securely in an automobile in order to allow a passenger to view the tablet in lieu of a conventional monitor integrated into the automobile. There is also a need for a device that is easily storable and transportable. There is also a need for a device that is capable of easy removable attachment to various objects and locations in addition to vehicles, such a cribs and other furniture, trees, walls, etc. There is also a need for a device that has the ability to securely hold other items of interest to young automobile passengers, such as valued toys, sippy cups, and other useful items.

### SUMMARY OF THE INVENTION

The present invention is directed to a magnetic attachment panel that satisfies the needs expressed above. A magnetic attachment panel having features of the present invention comprises a flexible base panel with a plurality of magnets integrated with the flexible base panel. The flexible base panel has a front panel and a rear panel with the plurality of magnets disposed between the front panel and rear panel. The flexible base panel can be many different shapes or sizes.

In an embodiment of the invention, the plurality of magnets are separated into magnetic sections by way of seams connecting the front panel to the rear panel. The seams are configured around the magnetic sections such that the magnets located within a particular magnetic section are confined to that magnetic section. Such confinement to particular magnetic sections ensures that the flexible base panel of the magnetic attachment panel remains sufficiently flexible to conform to the profile of a car seat and be capable of being rolled or folded into a closed configuration for storage and/or transportation. When rolled into the closed configuration, the plurality of magnetic sections attract to one another to help keep the magnetic attachment panel in the closed configuration.

In an alternative embodiment, the flexible base panel has a plurality of magnets affixed to its surface with sufficient space between magnets to allow the flexible base panel to be rolled or folded into a closed configuration for storage and/or transportation.

The plurality of magnets create a magnetic field and thus metallic or magnetic objects can be attached to the flexible base panel via the plurality of magnets. For example, a computer tablet with a metallic casing may be attached to the flexible base panel via the plurality of magnets. The number of magnets in close proximity to the metallic casing are sufficient in size and quantity in order to hold the computer tablet firmly against the surface of the flexible base panel via the magnetic field acting on metallic casing.

Many computer tablets are housed within plastic or leather casings or have no casing. An embodiment of the invention includes a computer tablet retainer. The computer tablet retainer includes a first mounting bracket and a second mounting bracket. The first and second mounting brackets each has a recessed base area within a recessed base slot sized to receive an edge of a computer tablet such that the recessed base area of the first mounting bracket receives one edge of a computer tablet and the recessed base area of the second mounting bracket receives the opposite edge of the computer tablet. The first and second mounting brackets also each has a left support slot and a right support slot sized to receive a left and right edge respectively of a computer tablet to ensure that the tablet is secured within the computer tablet retainer.

The computer tablet retainer has a metallic core capable and a soft exterior. The soft exterior ensures that the computer tablet is not scratched or otherwise damaged by the first and second mounting brackets of the computer tablet retainer. The metallic core ensures that that first and second mounting brackets will be bonded to the surface of the flexible base panel via the magnetic field acting on the metallic core. The magnetic field generated in the magnetic sections adjacent the first and second mounting brackets is sufficient to hold the computer tablet retainer and the computer tablet housed within securely to the flexible base panel. The magnetic field is also strong enough to securely hold the computer tablet retainer and the computer tablet housed within to the flexible base panel during ordinary driving conditions. However, the magnetic field is weak enough to allow an adult to detach the computer tablet retainer from the flexible base panel.

The front panel and rear panel of the flexible base panel are each formed with one or more receivers capable of receiving an attachment means that is interchangeable by the user depending on the use of the magnetic attachment panel. For example, an adjustable strap may be used as the attachment means in order to hang the magnetic attachment panel on the seat of a car by placing the adjustable strap around the headrest of the seat. The adjustable strap allows the magnetic attachment panel to be hung in a variety of locations within a vehicle, including on the front of the front passenger seat, the rear of either front seat, the front a rear seat, or even the rear of a rear seat for third row seat equipped vehicles. The adjustable strap also allows for easy removal of the magnetic attachment panel from the vehicle so that the magnetic attachment panel can be quickly stored or used in a different vehicle or location, such as a crib.

Once the computer tablet is attached to the flexible base panel via the computer tablet retainer, the computer tablet can be viewed in the same manner as a fully integrated monitor by a vehicle passenger. In addition, a child passenger can watch videos or interact with the tablet computer mounted to the magnetic attachment panel without the need to hold the device. In addition, toys or other objects such as a cup may be attached to the magnetic attachment panel if they have a metallic composition, or metallic panels or pieces attached.

### BRIEF DESCRIPTION OF THE DRAWINGS

The nature, objects, and advantages of the present invention will become more apparent to those skilled in the art after considering the following detailed description in connection with the accompanying drawings, in which like reference numerals designate like parts throughout, and wherein:

FIG. 1 is a perspective view of the magnetic attachment panel embodying features of the present invention and showing a computer tablet retainer attached to magnetic sections in a flexible base panel and also a handle connected to the flexible base panel;

FIG. 2 is a front view of the flexible base panel embodying features of the present invention and showing a plurality of magnets attached to the surface of the flexible base panel where the plurality of magnets are grouped in magnetic sections, including both circular magnets and magnet strip;

FIG. 3 is a side view of the flexible base panel shown in FIG. 2 showing the plurality of magnets attached to the surface of the flexible base panels;

FIG. 4 is a front view of an alternative flexible base panel of the magnetic attachment panel and embodying features of the present invention showing seams forming magnetic sections with the plurality of magnets within magnetic sections;

FIG. 5 is a cross-sectional view of the flexible base panel taken along line 3-3 of FIG. 4, showing the front panel and rear panel of flexible base panel with the plurality of magnets located between the front panel and rear panel in magnetic sections defined by seams;

FIG. 6 is a cross-sectional view of the flexible base panel taken along line 4-4 of FIG. 4, showing the front panel, rear panel and seams enclosing magnets within magnetic sections defined by seams;

FIG. 7 is a perspective view of the flexible base panel shown in FIG. 4 and showing the flexible base panel partially rolled upon itself;

FIG. 8 is a perspective view of the flexible base panel shown in FIG. 4 and showing the flexible base panel fully rolled into a closed configuration;

FIG. 9 is a perspective view of the first mounting bracket of the computer tablet retainer shown in FIG. 1 showing the metallic core in hidden dashed lines and the soft exterior enclosing the metallic core;

FIG. 10 is a top view of the first mounting bracket shown in FIG. 9 and showing the recessed base area with recessed base slot and vertical edge supports with corresponding edge support slots;

FIG. 11 is a side view of the first mounting bracket shown in FIGS. 9 and 10 and showing the recessed base area and vertical edge supports and showing the metallic core in hidden dashed lines;

FIG. 12 is a perspective view of a computer tablet with a second edge securely enclosed within a second mounting bracket and the first mounting bracket moving in a direction to securely enclose the first edge of the computer tablet;

FIG. 13 is a front view of a portion of the magnetic attachment panel and embodying features of the present invention showing a strap passed through receivers of the flexible base panel and attached to itself with an attachment mechanism;

FIG. 14 is a front view of another versions of the magnetic attachment panel and embodying features of the present invention showing ribbons based through the receivers;

FIG. 15 is a front view of the magnetic attachment panel shown in FIG. 1 and showing a computer tablet attached to the flexible base panel by way of a computer tablet retainer having a first mounting bracket and a second mounting bracket and toys also attached to the flexible base panel by way of metal tabs (shown in dashed lines) attached to the back side of the toys; and

FIG. 16 is a perspective view of the magnetic attachment panel of the present invention in use, showing the flexible base panel attached to the front seat of an automobile by a strap around the headrest of the seat magnetic attachment panel hanging from the neck rest of a front car with the front panel of the flexible base panel having a computer tablet attached to the front panel by way a computer tablet retainer and facing a child car seat also secured to the front seat such that the computer tablet is in view of the child car seat.

### DETAILED DESCRIPTION OF A PREFERRED EMBODIMENT

The present invention is a magnetic attachment panel, capable of having various metallic or magnetic objects attached to its surface and capable of being hung in various locations for use. After use, the magnetic attachment panel is capable of being easily rolled into a closed configuration and transported by the user.

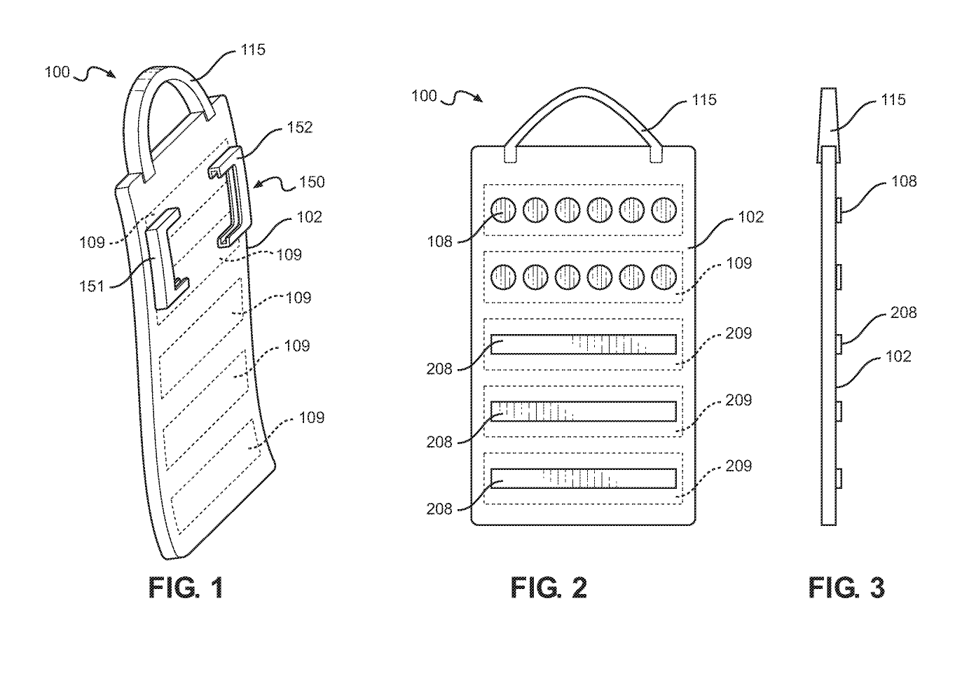

Referring initially to FIG. 1, an embodiment of the magnetic attachment panel embodying features of the present invention is shown and generally designated 100. The magnetic attachment panel 100 has a flexible base panel 102 with a plurality of magnetic sections 109 on the flexible base panel 102. Computer tablet retainer 150 includes a first mounting bracket 151 and a second mounting bracket 152. The first mounting bracket 151 and the second mounting bracket 152 are shown connected to the flexible base panel 102 at two magnetic sections 109. A plurality of magnets 108 (not shown in FIG. 1) are located within the magnetic sections 109. A strap 115 is shown permanently attached to flexible base panel 102.

In an embodiment of the invention, the magnets 108 are made from known alloys of iron, nickel, cobalt, gadolinium or any other materials that are known as permanent magnets. The flexible base panel can be made from known flexible materials, including but not limited to, rubber, latex, silicone, plastic, and neoprene.

Referring next to FIGS. 2 and 3, an alternative embodiment of the magnetic attachment panel is generally shown with a plurality of magnets 108 attached to the surface of flexible base panel 102 at magnetic regions 109. Single magnet strips 208 are connected to the flexible base panel 102 at magnetic regions 209. It is to be appreciated by those skilled in the art that the physical size, shape, and number of the magnets can be varied to best accommodate the items that intended to be bonded to the flexible base panel 102 by way of the magnets 108 and magnet strips 208. It is also to be appreciated by those skilled in the art that the magnets 108 and magnet strips 208 can be removably attached to the flexible base panel 102 by any means known in the art, such as hook and loop fabric strips or snap buttons. As so configured, magnets 108 and magnet strips 208 can be easily added or removed to the flexible base panel 102 as deemed necessary by a user. Strap 115 is shown attached to the flexible base panel 102. The magnets 108 create a magnetic field. Metallic or magnetic objects can be attached to the flexible base panel 102 of the magnetic attachment panel 100 at the magnetic sections 109 because of the magnetic fields generated by magnets 108 or magnet strips 208.

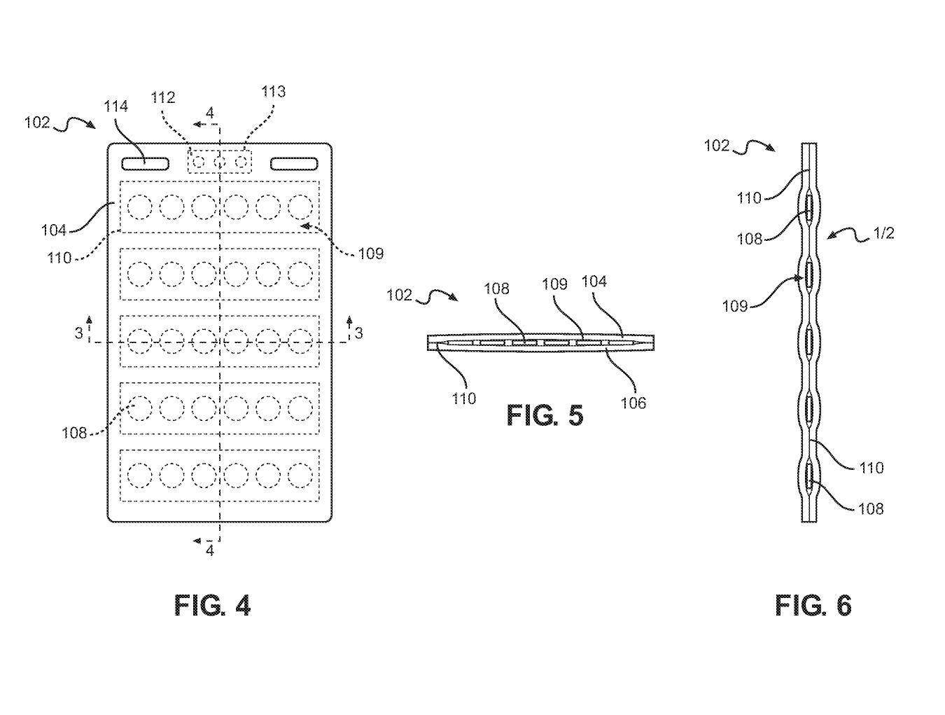

Referring next to FIG. 4, a front view of an alternative flexible base panel 102 is shown. Flexible base panel 102 is made up of a front panel 104 and rear panel 106 (shown in FIGS. 5 and 6) that are connected together at seams 110. The seams 110 also form magnetic sections 109 with magnets 108 located within magnetic sections 109 between the front panel 104 and rear panel 106 and shown in dashed lines. The front panel 104 and rear panel 106 are also each formed with a receiver 114. The receivers 114 are sized to receive a removable strap 115 (not shown). It is to be appreciated by those skilled in the art that any attachment means, such as a strap, rope, chain, ribbon, string, etc. can be passed through the receivers 114 in order to attach the flexible base panel 102 to an object such as a car seat, crib, or tree. The front panel 104 does not impede metallic objects from bonding to the flexible base panel 102 at the magnetic sections 109 as a result of the magnetic fields generated by the plurality of magnets 108.

The flexible base panel 102 can be various sizes and shapes depending on the intended use of the magnetic attachment panel 100. For example, the flexible base panel 102 may be rectangular (as shown in FIGS. 1 through 4 above), circular or any other shape known to those skilled in the art. In a preferred embodiment, the front panel 104 and the rear panel 106 of flexible base panel 102 is made out of various flexible materials known to those skilled in the art, which allows a user to roll the flexible base panel 102 into a closed configuration. These materials include, but are not limited to, rubber, latex, silicone, plastic, and neoprene. In addition, flexible base panel 102 can have various colors or designs known to those skilled in the art. Securing magnets 113 are shown in dashed lines within a securing magnetic sections 112 located between receivers 114. The function of the securing magnets are to assist in keeping the flexible base panel 102 securely in the closed position set forth in FIG. 8.

Although the plurality of magnetic sections 109 are shown in FIG. 4 as five substantially rectangular magnetic sections 109 arranged vertically with six circular magnets 108 located within each magnetic sections 109, various configurations known to those skilled in the art would not depart from the scope and spirit of the present invention. Possible arrangements for the magnetic sections 109 may include, but are not limited to a flexible base panel 102 formed with a front panel 104 made of magnetic material bonded to a rear panel 106 made of rubber wherein the entire front panel 104 functioned as the magnetic section 109. Moreover, permanently magnetized materials have various magnetic field strengths and the composition of the magnets 108 and strength of the magnetic fields emanating from the magnetic sections 109 can vary depending of the desired use of the magnetic attachment panel 100. For example, an object of a greater mass would require a stronger magnetic field to firmly attach the object to the magnetic attachment panel 100. The stronger magnetic field can be realized by increasing the size and/or quantity of magnets located in a particular magnetic section.

Referring next to FIG. 5, a cross section of the flexible base panel 102 is shown along the lines 3-3 of FIG. 4. A plurality of magnets 108 are shown within a single magnetic section 109. Similarly, in FIG. 6 a cross section of the flexible base panel 102 is shown along the lines 4-4 of FIG. 4. FIG. 6 shows multiple magnetic sections 109 with magnets 108 located therein with the magnetic sections 109 formed by seams 110.

The front panel 104 may be attached to the rear panel 106 at seams 110 by any means known to those skilled in the art. Means of attaching the front panel 104 to the rear panel 106 include, but are not limited to, adhesives, sewing, heat bonding, and chemical bonding. Once magnets 108 are secured within a particular magnetic section 109, the magnets 108 cannot move to another magnetic section 109. However, magnets 108 enclosed in a particular magnetic section 109 can move within that particular magnetic section 109. As noted above, the embodiment discussed in connection with FIGS. 2 and 3 does not limit the number of magnets 108 that can be added to or removed from any particular magnetic section 109.

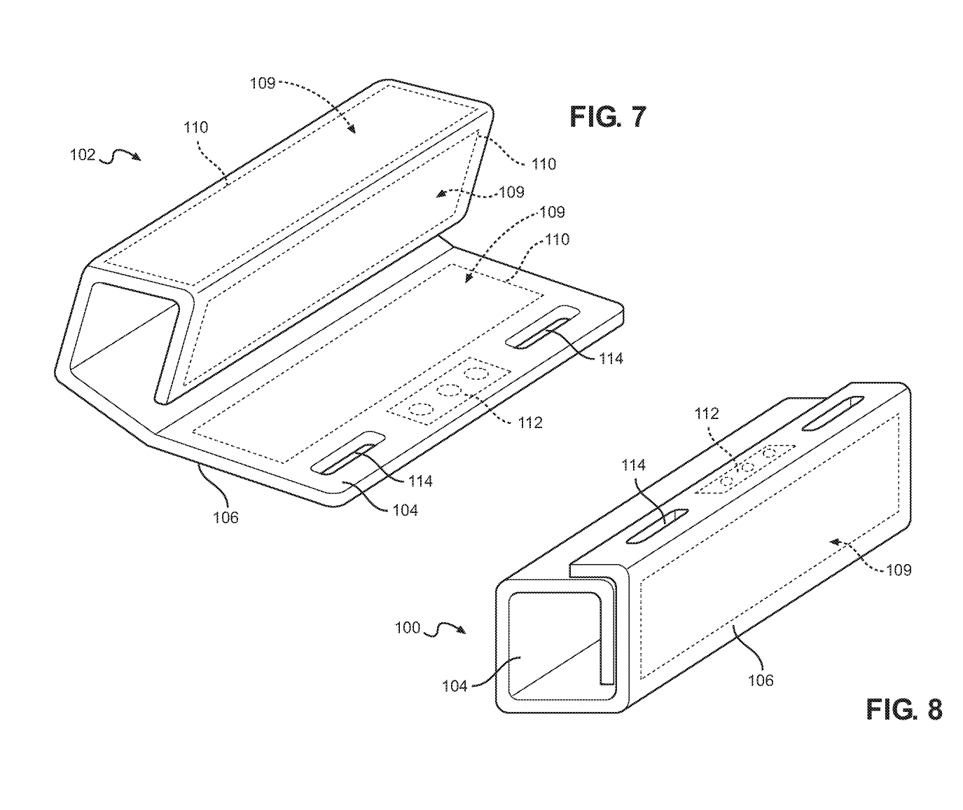

After use, the magnetic attachment panel 100 of the present invention can be rolled into a closed configuration for transportation. FIG. 7 shows the flexible base panel 102 partially rolled into a closed configuration. As shown in FIG. 4, the magnetic sections 109 are separated from one another by seams 110. Because the seams 110 consist only of the material used for the front panel 104 and rear panel 106, the locations of the seams 110 act as joints. Thus, seams 110 allow a user to roll the flexible base panel 102 into a closed configuration. When the flexible base panel 102 is in a closed configuration, the magnetic fields (not shown) of the adjacent magnetic section 109 attract one another and secures the flexible base panel 102 in a closed configuration until future use.

FIG. 8 shows the flexible base panel 102 in a closed configuration. The size, shape, and arrangement of the magnetic sections 109 and the magnets 108 located therein will alter the shape of flexible base panel 102 will assume in a closed configuration. The securing magnetic section 112 further secures the flexible base panel 102 by securing the area between the receivers 114 to other magnetic sections 109.

When a user wishes to use the magnetic attachment panel 100, the user applies force to break the attraction between the magnetic fields and unroll the flexible base panel 102 to an open configuration (as shown in FIGS. 1 through 4).

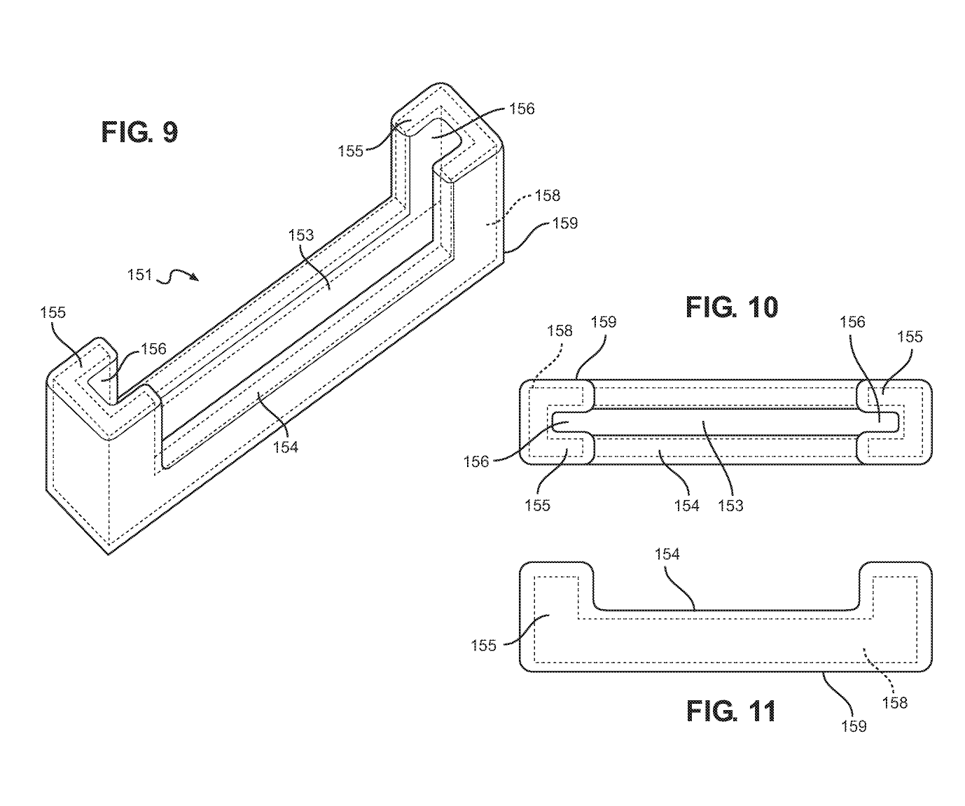

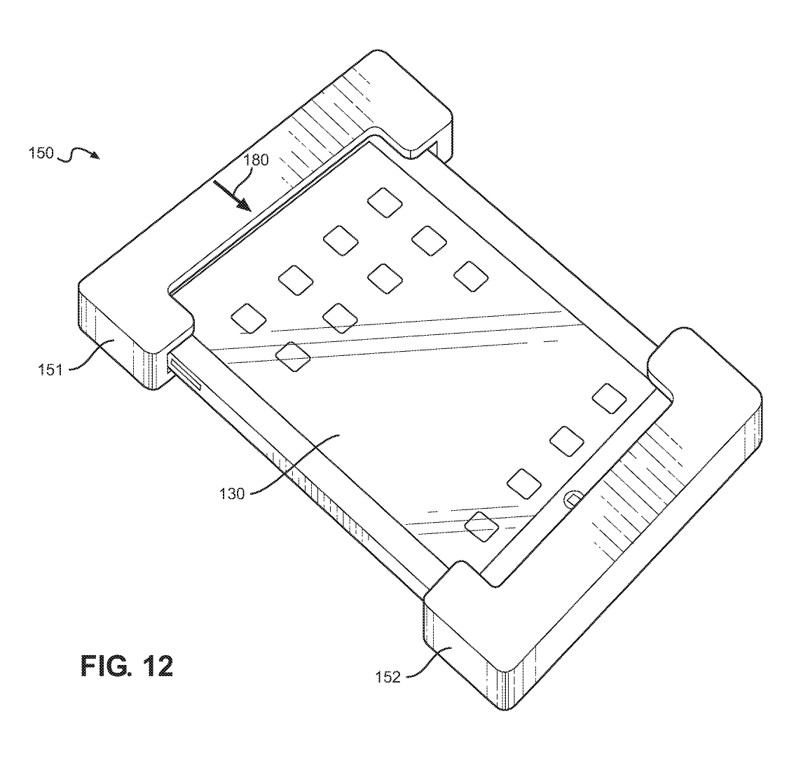

Referring next to FIGS. 9 through 11, a first mounting bracket 151 of a computer tablet retainer 150 is shown. The first mounting bracket 151 has a recessed base area 154 and a vertical edge support 155 on either side of the recessed base area 154. The recessed base area 154 has a recessed base slot 153 sized to receive an edge of a computer tablet (not shown). Each vertical edge support 155 also has an edge support slot 156 sized to partially receive an edge of a computer tablet. The first mounting bracket 151 is configured identically to second mounting bracket 152 (shown in FIG. 12). The first mounting bracket 151 and second mounting bracket 152 each has a metallic core 158 with a soft exterior coating 159. The metallic core 158 can be made of a permanent magnet material or simply metal that can be attracted to permanent magnet material. The soft exterior coating 159 can be made of any soft material including but not limited to cloth, leather, plastic, rubber, silicon, neoprene, plastic or latex. The soft exterior coating 159 is designed to prevent scratches or damage to a computer tablet housed within the first and second mounting brackets 151 and 152.

Referring next to FIG. 12, a computer tablet 130 is shown with an edge enclosed in the recessed base slot 153 of second mounting bracket 152 of computer tablet retainer 150. The sides of the computer tablet 130 near the edge of the tablet 130 are also in contact with the edge support slot 156 and are prevented from side to side movement by the vertical edge supports 155. Similarly, the first mounting bracket 151 is positioned opposite the second mounting bracket 152 moved in direction 180 such that the opposite edge of the computer tablet 130 is enclosed in the recessed base slot 153 of the first mounting bracket 151. The sides of the computer tablet 130 near the opposite edge of the computer tablet 130 are in contact with the edge support slot 156 and are prevented from side to side movement by the vertical edge supports 155. Once the computer tablet is securely housed within the first mounting bracket 151 and second mounting bracket 152 of the computer tablet retainer 150, the computer tablet retainer 150 and enclosed computer tablet 130 can be attached to the flexible base panel 102 by positioning the computer tablet retainer 150 over one or more magnetic sections 109 until the magnetic field bonds the computer tablet retainer 150 to the flexible base panel 102.

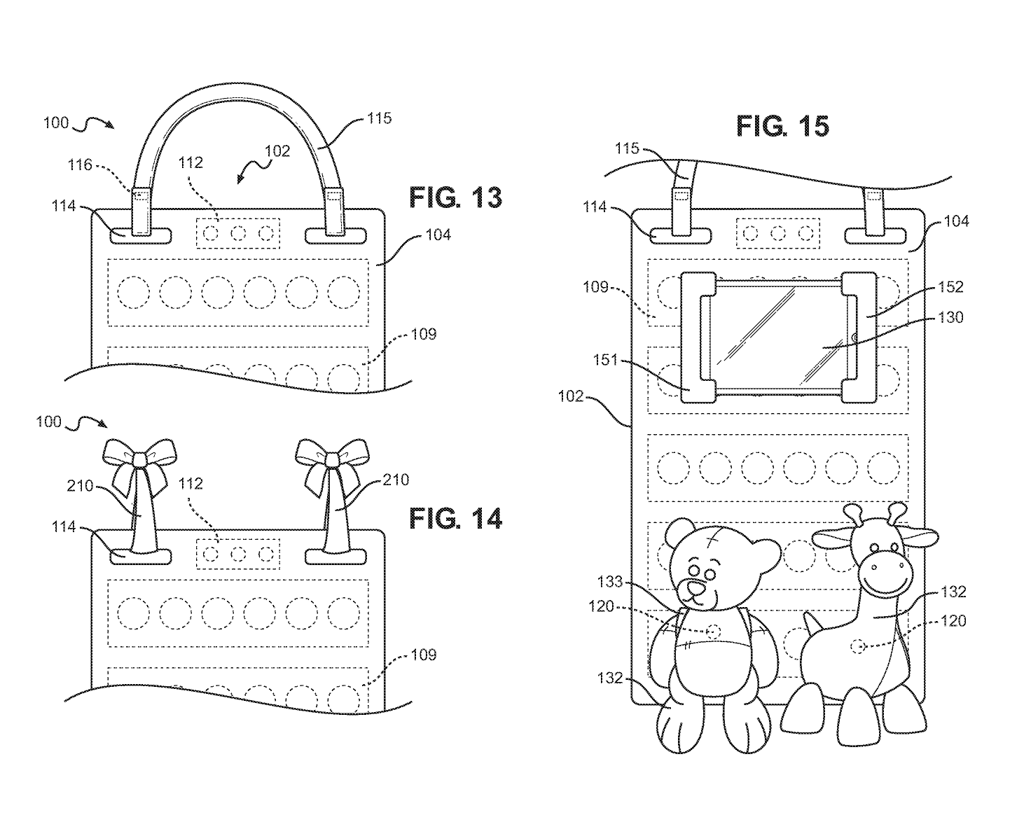

Referring now to FIGS. 13 and 14, non-limiting examples of attachment means are shown. In FIG. 13, each end of strap 115 is pulled through one receiver 114 and attached to itself using an attachment mechanism 116, forming a loop. Thus, strap 115 can be used to hang the magnetic attachment panel 100 around various objects. For example, as shown below in FIG. 16, the strap 115 may be hung around headrest 137 of car seat 136, allowing the magnetic attachment panel 100 to lie against the car seat 136.

In FIG. 14, an attachment means utilizing two ribbons 210 is shown. Each ribbon 210 is received through receiver 114. Each ribbon 210 is then tied around an object to secure the magnetic attachment panel 100 to that object. For example, a user may secure the magnetic attachment panel 100 to the side of a crib (not shown) by tying each ribbon 210 to a horizontal bar of the crib. As discussed above, a user's ability to use different attachment means interchangeably, allows a user to use the magnetic attachment panel 100 in many different circumstances and to employ creativity in determining how and where to use the magnetic attachment panel 100.

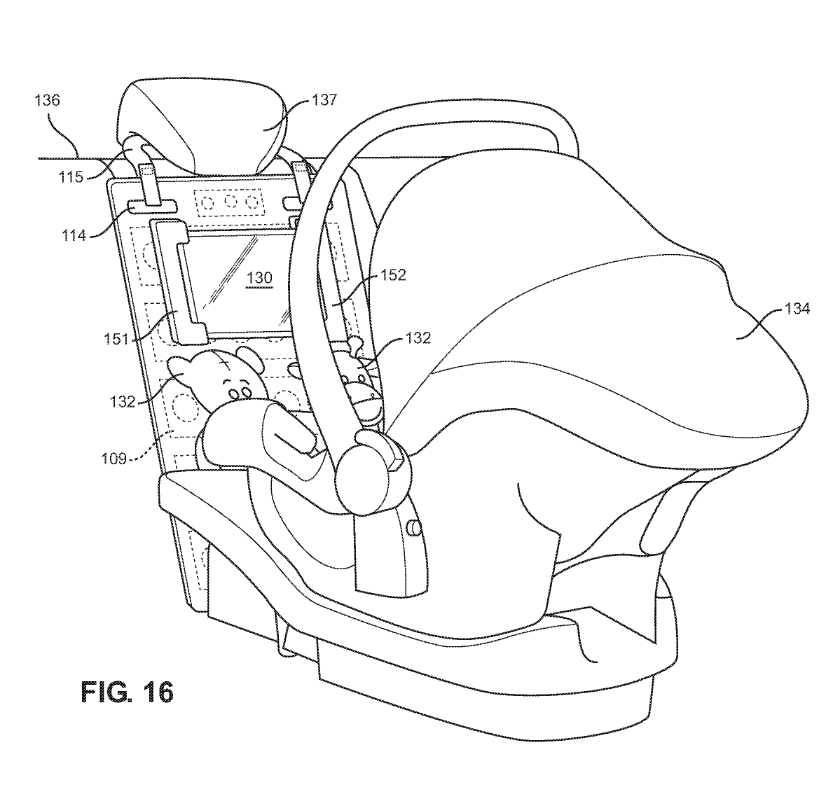

Any magnetic or metallic object may be attached to the magnetic attachment panel 100. FIG. 15 shows examples of objects attached to the flexible base panel 102 of the magnetic attachment panel 100, including a tablet computer 130 and toys 132. In order to attach objects that are not innately magnetic or metallic in composition, the user may attach a magnet or metallic accessory tab 120 to a toy 132 by any means known by those skilled in the art. Another possible means of attaching objects that are not characteristically metallic or magnetic would be to utilize a harness 133, as shown in FIG. 15. The harness would be magnetic or metallic and fastened to toy 132 by some mechanism other than by use of a magnetic field. A non-limiting example would be a harness 133 formed as a means to hold the toy 132, where the harness would act as a backpack and hook around the arms of the toy 132 or in some other fashion.

Referring to FIG. 16, a perspective view of the magnetic attachment panel 100 is shown in use. The attachment panel 100 is connected to a car seat 136 by way of a strap 115 passed around a headrest 137 and connected to the flexible base panel 102 at receivers 114. The flexible base panel 102 conforms to the profile of the car seat 136. A child car seat 134 is attached to the car seat 136 and faces the flexible base panel 102. A computer tablet 130 is mounted to the flexible base panel 102 by way of a computer tablet retainer 150 comprising a first mounting bracket 151 and a second mounting bracket 152. The first mounting bracket 151 and second mounting bracket 152 each have a metallic core 158 (shown in FIGS. 9-11) that is drawn to and attached to flexible base panel 102 as a result of the magnetic field emanating from the magnetic sections 109. The computer tablet 130 is viewable by a passenger in child car seat 134. Additionally, toys 132 are mounted to flexible base panel 102 by way of metallic accessory tabs 120 (not shown) attached to the back of toys 132. The metallic accessory tabs 120 are drawn to and connected to the flexible base panel 102 by reason of the magnetic field emanating from the magnetic sections 109. Through use of the magnetic attachment panel 100, the toys 132 and computer tablet 130 are mounted in much closer proximity to the child occupant in child seat 134 who, in the absence of applicant's invention, would otherwise have no ability to view or interact with the toys 132 or computer tablet 130 without being required to hold the same.

While there have been shown what are presently considered to be preferred embodiments of the present invention, it will be apparent to those skilled in the art that various changes and modifications can be made herein without departing from the scope and spirit of the invention.

What is claimed is:

1. A magnetic attachment panel comprising:
a flexible base panel;
a plurality of magnets attached to said flexible base panel; and
a strap attached to said flexible base panel.

2. The magnetic attachment panel of claim 1 further comprising a computer tablet retainer capable of removably attaching to said at plurality of magnets by reason of magnetic field generated by said plurality of magnets.

3. The magnetic attachment panel of claim 2 wherein said computer tablet retainer comprises a metal case partially enclosing a computer tablet.

4. The magnetic attachment panel of claim 2 wherein said computer tablet retainer comprises a first mounting bracket and a second mounting bracket wherein said first mounting bracket is sized to receive a first edge of a computer tablet and said second mounting bracket is sized to receive a second edge of said computer tablet opposite said first edge of said computer tablet.

5. The magnetic attachment panel of claim 4 wherein said first mounting bracket and said second mounting bracket have a metallic core and a soft exterior surface fully encapsulating said metallic core.

6. The magnetic attachment panel of claim 1 further comprising one or more toys having a metallic accessory tab connected thereto wherein said toy can be removably attached to any said one or more said plurality of magnets through magnetic bonding between said one more plurality of magnets and said metallic accessory tab.

7. The magnetic attachment panel of claim 1 wherein said flexible base panel further comprises a front panel and a rear panel wherein said front panel is connected to said rear panel at seams and wherein said plurality of magnets are enclosed between said front panel and said rear panel.

8. The magnetic attachment panel of claim 7 wherein said seams form one more or more magnetic sections wherein at least one of said plurality of magnets is located in each said one or more magnetic sections.

9. A magnetic attachment panel comprising:
a flexible base panel having a front panel and a rear panel connected together at seams wherein said seams form one or more magnetic sections;
at least one magnet located in each said one or more magnetic sections;
one or more receivers in said flexible base sized to receive a means for attaching said receiver of said flexible base to an object;
a computer tablet retainer capable of magnetically attaching to one or more said magnetic sections of said flexible base and capable of securely holding a computer tablet while said computer tablet retainer is magnetically attached to one or more said magnetic sections of said flexible base.

10. The magnetic attachment panel of claim 9 wherein said computer tablet retainer comprises a first mounting bracket and a second mounting bracket.

11. The magnetic attachment panel of claim 10 wherein said first mounting bracket and said second mounting bracket each has a recessed base area with a recessed base slot sized to receive an edge of a computer tablet.

12. The magnetic attachment panel of claim 11 wherein said first mounting bracket and said second mounting bracket each has vertical edge supports on either side of said recessed base area wherein each vertical edge support has an edge support slot sized to partially receive an edge of a computer tablet.

13. The magnetic attachment panel of claim 12 wherein said first mounting bracket and said second mounting bracket have a metallic core and a soft exterior surface fully encapsulating said metallic core.

14. The magnetic attachment panel of claim 9 further comprising one or more toys having a metallic accessory tab connected thereto wherein said toy can be removably attached to any said one or more magnetic sections of said base through magnetic bonding between said one more magnetic sections and said metallic accessory tab.

15. The magnetic attachment panel of claim 9 further comprising a harness that can be removably attached to any said one or more magnetic sections of said base through magnetic bonding between said one more magnetic sections and said harness.

16. The magnetic attachment panel of claim 9 wherein said front panel and said rear panel of said flexible base panel are made of neoprene.

17. The magnetic attachment panel of claim 9 wherein said means for attaching said one or more receivers of said flexible base to said object is a strap.

18. The magnetic attachment panel of claim 9 wherein said means for attaching said one or more receivers of said flexible base to said object is a ribbon.

19. A method of use of a magnetic attachment panel comprising the steps of:
(a) providing a magnetic attachment panel comprising
a flexible base panel having a front panel and a rear panel connected together at seams wherein said seams form one or more magnetic sections;
at least one magnet located in each said one or more magnetic sections;
a receiver in said flexible base sized to receive a means for attaching said receiver of said flexible base to an object;
a computer tablet retainer capable of magnetically attaching to one or more said magnetic sections of said flexible base and capable of securely holding a computer tablet while said computer tablet retainer is magnetically attached to one or more said magnetic sections of said flexible base;
(b) attaching said magnetic attachment panel to a car seat;
(c) attaching a computer tablet to said computer tablet retainer;
(d) attaching said computer tablet retainer to said flexible base at one or more said magnetic sections of said flexible base; and
(e) viewing said computer tablet on said magnetic attachment panel.

20. The method of claim 19 further comprising the steps of:
(f) removing said computer tablet retainer from said flexible base panel;
(g) detaching said magnetic attachment panel from said car seat; and
(h) rolling said flexible base panel of said magnetic attachment panel to a closed position.
